(19) United States
(12) Patent Application Publication
(10) Pub. No.: US 2014/0033609 A1
(43) Pub. Date: Feb. 6, 2014

(54) EXPANDABLE PLANT GROWTH SYSTEM

(71) Applicants: Gregory J. Tyler, Mission Viejo, CA (US); Randal G. Tyler, Mission Viejo, CA (US)

(72) Inventors: Gregory J. Tyler, Mission Viejo, CA (US); Randal G. Tyler, Mission Viejo, CA (US)

(21) Appl. No.: 13/562,742

(22) Filed: Jul. 31, 2012

(51) Int. Cl. A01G 31/02; A01G 31/06

(52) U.S. Cl. 47/62 R

(57) ABSTRACT

An expandable plant growth system by which different varieties of plants and plant clones can be grown indoors with neither seeds nor soil. The plant growth system includes a plurality of tiers that are stacked one above the other. Each tier includes a water support tray that surrounds a hollow plant support frame. A root irrigation channel runs around each of the water support trays. Water is pumped from a reservoir to the root irrigation channels around the water support trays. The plant support frame retains the plants such that the roots thereof are held within the root irrigation channels to receive water and nutrients therefrom. Water is returned to the reservoir under the influence of gravity by a series of water transfer tubes which connect the root irrigation channels to each other and to the reservoir.

### BACKGROUND OF THE INVENTION

1. Field of the Invention

This invention relates to an expandable plant growth system having tiered water supply trays and root irrigation channels that are arranged one above the other so that one or more varieties of plants and plant clones can be grown with neither seeds nor soil. The system also has a self-contained water flow path including a reservoir from which water is pumped and to which water is returned so that the plants being grown are continuously supplied with water and nutrients.

2. Background Art

One technique for growing plants indoors is known as aeroponics by which the roots of individual plants float in air rather than soil. The roots are typically misted with a mixture of water and nutrients. However, should the roots be deprived of moisture for as little as 15 minutes, the entire plant yield could be lost.

Another technique for growing plants indoors is known as hydroponics where the roots of the plants are immersed in plain water or water containing nutrients. In this case, the plant yield is often not as high as with aeroponics.

A nutrient silt film has been used to promote plant growth when nutrients which are added to standing water fall to the bottom to create a thin nutrient layer. While the roots receive enrichment from the nutrient layer, they are often denied the aeration needed to achieve maximum growth.

Drip systems are commonly used to control the amount of water that is applied directly to the plant roots through a set of orifices in water supply pipes or tubes. In this case, however, the roots lack the nutrients that promote growth.

Each of the conventional growth systems described above has certain benefits and disadvantages. It would therefore be desirable to create a new hybridized plant growth system within which the benefits of all of the aforementioned systems are advantageously merged.

### SUMMARY OF THE INVENTION

In general terms, an expandable plant growth system is disclosed by which one or more varieties of plants and plant clones can be grown indoors with neither seeds nor soil. The plant growth system includes a hollow plant support frame that holds the plants to be grown such that roots extend outwardly from the frame and the leaves extend inwardly thereof. A plurality of tiers are stacked one above the other around the plant support frame. Each tier includes a water supply tray attached to the outside of the frame and a root irrigation channel which runs around the tray to receive and water the roots.

The plant growth system also includes a self-contained water flow path by which water is continuously circulated between a water and nutrient filled reservoir and the root irrigation channels of the water supply trays of the stack of tiers. A water supply tube surrounds the plant support frame above each root irrigation channel of each tier. The water supply tubes are connected to one another and to the reservoir by means of a series of water transfer tubes. Water from the reservoir is pumped upwardly to the water supply tube located above the root irrigation channel of the top-most tier by way of a water inlet line. Water drip orifices are drilled into each water supply tube so as to lie above each of the roots of the plants being held by the plant support frame. Water drips from the water drip orifices formed in the water supply tubes onto the roots so that the water is collected by the root irrigation channels below the water supply tubes. Water within the root irrigation channels flows downwardly to the reservoir under the influence of gravity through the series of water transfer tubes.

### BRIEF DESCRIPTION OF THE DRAWINGS

FIG. 1 shows an expandable plant growth system according to a preferred embodiment of the present invention;

FIG. 2 is a top view of the plant growth system taken along lines 2-2 of FIG. 1; and

FIG. 3 is an enlarged detail of the plant growth system taken in the direction of the line of sight designated “3” in FIG. 1.

### DESCRIPTION OF THE PREFERRED EMBODIMENT

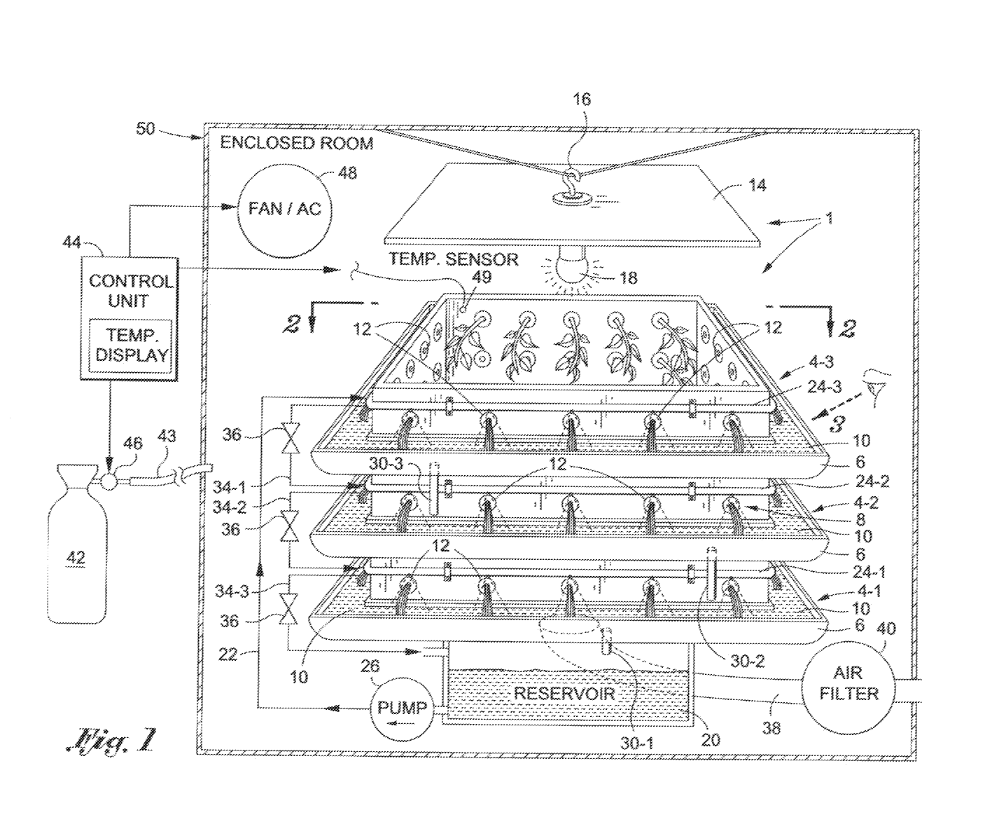

Referring concurrently to FIGS. 1-3 of the drawings, there is shown a preferred embodiment for an expandable plant growth system 1 by which one or more varieties of plants and plant clones can be efficiently grown with neither seeds nor soil. The plant growth system 1 is tiered so that it can be expanded on an as-needed basis to increase the plant yield. As will soon be explained, the system is self-sustaining, such that sources of water and light other than those provided by the system itself will not be required to promote plant growth. Therefore, the system 1 can be advantageously used indoors, especially at locations where the outdoors environment is potentially hostile or insufficient to support plant growth.

The plant growth system 1 is housed within an enclosure 50. The walls of the enclosure 50 are manufactured from an insulating material (e.g., PVC) to help maintain a desired temperature. The plant growth system 1 includes a plurality of tiers 4-1, 4-2 and 4-3 that are stacked one above the other. A total of three tiers 4-1 . . . 4-3 are shown in FIG. 1. However, this is for the purpose of example only, and the system 1 can be expanded or contracted by varying the number of tiers depending upon the plant yield which is required.

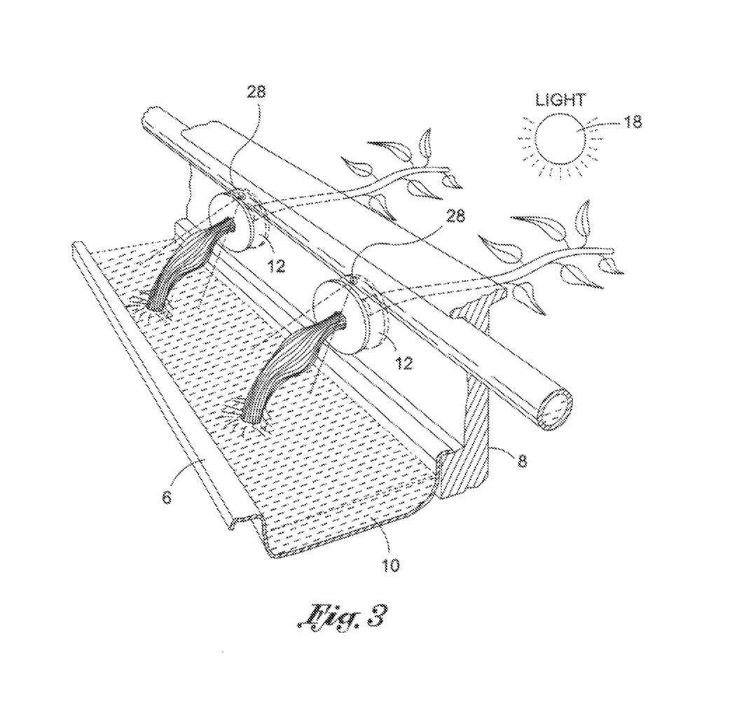

Each of the tiers 4-1 . . . 4-3 of the plant growth system 1 includes a (e.g., rectangular) water supply tray 6 that surrounds a hollow (e.g., rectangular) plant support frame 8. More particularly, the water supply trays 6 are spaced vertically from each other around the plant support frame 8. The water supply trays 6 have troughs or depressions formed therein (best shown in FIG. 3) to create root irrigation channels 10. The water supply trays 6 and the plant support frame 8 are manufactured from a chemically-inert material such as acrylic or any other suitable lightweight and impact resistant material.

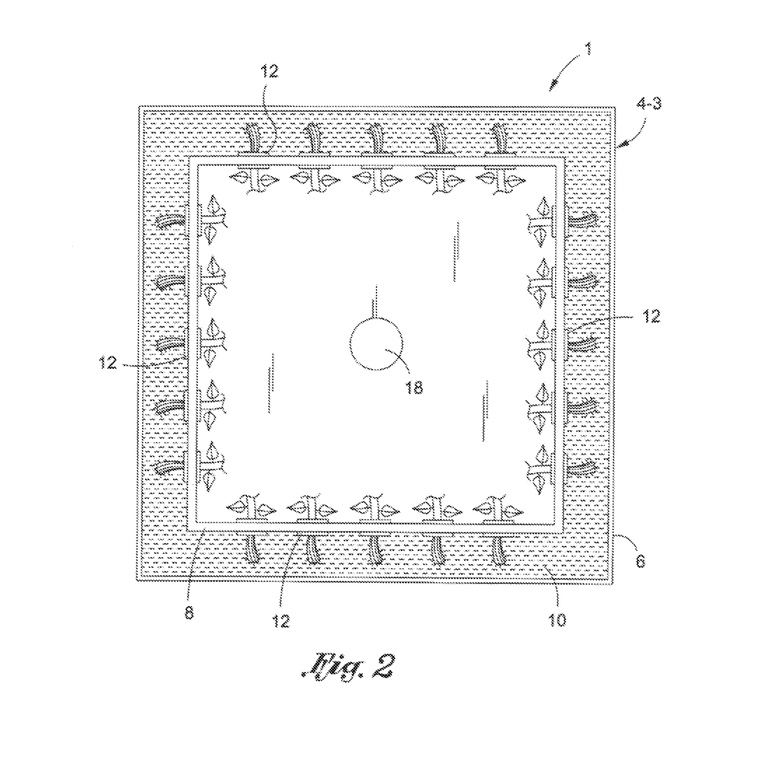

A plurality of holes are formed through each of the sides of the plant support frame 8 of the plant growth system 1. Each hole is sized to receive the roots of one of the plants to be grown by system 1. Located within each hole is a (e.g., neoprene) sleeve 12 by which to surround and hold the plants in place. As is best shown in FIGS. 2 and 3, the plants are retained by the sleeves 12 such that the stems and leaves of the plants to be grown extend inwardly from the sides of the hollow plant support frame 8 towards the interior thereof. The roots of the plants extend outwardly from the sides of the support frame 8 where they are first aerated and then received by the root irrigation channels 10 of the tiered water supply trays 6 that surround the support frame 8.

The top of the plant support frame 8 of the plant growth system 1 is closed by a lid 14. The bottom of the lid 14 is preferably covered with a light-reflecting (e.g., Mylar) material. A hook 16 is attached to the top of the lid 14 so that the lid can be lifted off the plant support frame 8 when access is desirable to the hollow interior thereof in order to add to or remove plants from the system. A source of light (e.g., a 200 watt CFL bulb) 18 is mounted at the bottom of the lid 14. With the lid 14 in place atop the plant support frame 8, the leaves of the plants which lie inside the frame will be bathed in light to promote growth.

Located below the bottom-most tier 4-1 of the stack of tiers from the plant growth system 1 is a reservoir 20. The reservoir 20 is filled with water and nutrients to enable the plants that are retained at the plant support frame 8 to thrive. The reservoir 20 is part of a self-contained water flow path by which water is continuously circulated between the reservoir and tiered water supply trays 6. A water inlet line 22 runs from the reservoir 20 upwardly to a water supply tube 24-3 that is held in surrounding engagement with the plant support frame 8 at a location above the water supply tray 6 of the top-most tier 4-3 of the stack of tiers. A conventional pump (e.g., such as a fish tank pump, or the like) 26 pumps the water and plant nutrients from the reservoir 20 to the water supply tube 24-3 of tier 4-3 by way of the water inlet line 22.

Water supply tubes 24-1 and 24-2 are held in surrounding engagement with the plant support frame 8 at locations above respective water supply trays 6 of the bottom-most and intermediate tiers 4-1 and 4-2 of the stack of tiers of the plant growth system 1. As is best shown in FIG. 3, a series of water drip orifices 28 are drilled through each of the water supply tubes 24-1 . . . 24-3. The water drip orifices 28 are located in the tubes 24-1 . . . 24-3 so as to lie directly above the sleeves 12 through the plant support frame 8 and the plant roots which are retained by the sleeves.

A first water transfer tube 30-1 runs from the root irrigation channel 10 of the water supply tray 6 of the bottom-most tier 4-1 of the stack of tiers to the reservoir 20. A second water transfer tube 30-2 runs from the root irrigation channel 10 of the water supply tray 6 of the intermediate tier 4-2 to the root irrigation channel 10 of the bottom-most tier 4-1. A third water transfer tube 30-3 runs from the root irrigation channel 10 of the water supply tray 6 of the top-most tier 4-3 to the root irrigation channel 10 of the intermediate tier 4-2. The water transfer tubes 30-1 . . . 30-3 communicate with one another and with the reservoir 20 to create a serial flow path so that water is continuously delivered to each root irrigation channel 10 of the plant growth system 1.

More particularly, water is transferred under the influence of gravity via successive water transfer tubes 30-3 . . . 30-1 from the root irrigation channels 10 of the water supply trays 6 of the tiers 4-3 . . . 4-1 to the reservoir 20. The water is then pumped by the pump 26 from reservoir 20 back to the root irrigation channel 10 of the tray 6 of the top-most tier 4-3 via the water inlet line 22. Thus, nutrients in the water settle to the bottom of each of the root irrigation channels 10 of each of the tiers 4-1 . . . 4-3 to form layers of silt in order to feed the roots of the plants which extend outwardly from the sides of the plant support frame 8.

A first water return line 34-1 is connected between the water supply tubes 24-3 and 24-2 of the top-most and intermediate tiers 4-3 and 4-2 of the system 1. A second water return line 34-2 is connected between the water supply tubes 24-2 and 24-1 of the intermediate and bottom-most tiers 24-2 and 24-1. A third water return line 34-3 is connected between the water supply tube 24-1 of the bottom-most tier and the reservoir 20. A control valve 36 is located in each of the first, second and third water return lines 34-1 . . . 34-3. The water return lines 34-1 . . . 34-3 communicate with one another (via valves 36) to create a serial water outlet path so that water from the water supply tube 24-3 of the top-most tier is returned to the reservoir 20 by way of the water supply tubes 24-2 and 24-3 of the intermediate and bottom-most tiers 4-2 and 4-1.

Water is circulated through the plant growth system 1 by first being pumped upwardly from the reservoir 20 and then being returned downwardly to the reservoir by way of the water inlet line 22, the water supply tubes 24-1 . . . 24-3, the root irrigation channels 10, and the water return lines 34-1 . . . 34-3. When the control valves 36 are opened, water will drip outwardly from the water drip orifices (28 of FIG. 3) formed in the supply tubes 24-1 . . . 24-3 to nurture the roots located in the root irrigation channels 10 immediately below the drip orifices. Water is sprayed from the orifices 28 in cases where the pressure within the water supply tubes increases. When it is desirable to clean the plant growth system 1, the control valves 36 are closed. Therefore, the aforementioned serial water outlet path which runs through the water return lines 34-1 . . . 34-3 and carries water back to the reservoir 20 will be correspondingly closed. In this case, most of the water with which the root irrigation channels 10 are filled will eventually drain under the influence of gravity to the reservoir 20 by way of the serial connected water transfer tubes 30-1 . . . 30-3.

An air exhaust hose 38 runs from a convenient location (for example, at the bottom of the stacked tiers 4-1 . . . 4-3) to the exterior of the enclosure 50 within which the plant growth system 1 is housed. The exhaust hose 38 preferably communicates with an in-line centrifugal fan (not shown) so that hot or cold air can be blown out of the enclosure 50 into the atmosphere. An air filter 40 is located in the air exhaust hose 38 to permit any loose plant debris to be trapped and removed.

To improve the growth rate of the plants, an optional external tank 42 of carbon dioxide gas is coupled to the system 1 within the enclosure 50 by way of tubing 43. An environmental control unit 44 having a temperature display is located outside the enclosure 50 to be connected to each of a regulator 46 of the tank 42 and a heating and cooling unit 48 that is located within the enclosure 50. The heating and cooling unit 48 may include one or more of a fan, an air conditioner and a heater.

It has been found that plant growth can be maximized by maintaining the temperature within the enclosure 50 in a range of 60-105° F. depending upon the plants being grown. The environmental control unit 44 can be manually set to be automatically responsive to the heat and humidity within the enclosure 50 so that the gas tank 42 and/or the heating and cooling unit 48 can be operated as is needed to achieve the ideal growing conditions for the plants within the enclosure 50. To this end, a temperature sensor 49 (of FIG. 1) is located inside the hollow plant support frame 8 to communicate with the control unit 44 outside the enclosure 50.

By virtue of the expandable plant growth system 1 disclosed above, any one type or a variety of different plants may be grown effectively and faster with a more compressed node expression than had the plants been grown in soil. The stackable tiers and the plurality of plant-retaining holes formed in the plant support frame 8 maximize the available growing surface. Plants and plant clones can be grown in a controlled environment at a high success rate indoors and without natural sunlight.

1. A system for growing plants having roots, said system comprising:
a plant support frame having an inside and an outside and a plurality of openings formed therethrough, the plants to be grown being received and retained by respective ones of said plurality of openings such that the leaves of the plants are located at the inside of said plant support frame and the roots of the plants are located at the outside of said plant support frame;
at least first and second root irrigation channels surrounding said plant support frame and being spaced one above the other to receive the roots of the plants located outside said plant support frame; and
a source of water communicating with each of said first and second root irrigation channels to supply water to said channels and thereby water the roots received by said channels.

2. The plant growing system recited in claim 1, further comprising at least first and second water supply trays extending around the outside of said plant support frame and being stacked one above the other, respective ones of said first and second root irrigation channels running around said first and second water supply trays.

3. The plant growing system recited in claim 1, wherein said source of water is a water filled reservoir located below said first and second root irrigation channels, said reservoir communicating with each of said first and second root irrigation channels by means of a pump.

4. The plant growing system recited in claim 1, wherein said source of water communicates with each of said first and second root irrigation channels by way of a water inlet line extending from said source to said second root irrigation channel, said second root irrigation channel lying above said first root irrigation channel.

5. The plant growing system recited in claim 4, wherein said source of water also communicates with each of said first and second root irrigation channels by means of a first water transfer line running from said second root irrigation channel to said first root irrigation channel and a second water transfer line running from said first root irrigation channel to said source.

6. The plant growing system recited in claim 1, further comprising first and second water supply tubes attached to said plant support frame and communicating with one another, said first water supply tube lying above said first root irrigation channel, said second water supply tube lying above said second root irrigation channel, and said second water supply tube lying above said first water supply tube, and a water inlet line extending between said source of water and said second water supply tube.

7. The plant growing system recited in claim 6, further comprising a first water return line extending between said second water supply tube and said first water supply tube and a second water return line extending between said first water supply tube and said source of water.

8. The plant growing system recited in claim 7, wherein said first and second water return lines have respective first and second valves connected therewithin, said first and second valves having an open position to permit water to flow through said first and second water return lines to said source of water, and said valves having a closed position to block the flow of water through said water return lines to said source.

9. The plant growing system recited in claim 6, wherein each of said first and second water supply tubes extends around said plant support frame and has a plurality of orifices formed therein, each of said plurality of orifices lying directly above the roots of a plant located outside said plant support frame such that water from said source of water drips onto the roots of the plants by way of said plurality of orifices.

10. The plant growing system recited in claim 9, wherein the water which drips through the plurality of orifices formed in said first water supply tube is collected by said first root irrigation channel, and the water which drips through the plurality of orifices formed in said second water supply line is collected by said second root irrigation channel.

11. The plant growing system recited in claim 1, further comprising a light source located at the inside of said plant support frame to bathe the leaves of the plants in light.

12. The plant growing system recited in claim 1, further comprising an enclosure to surround said plant support frame, said first and second root irrigation channels, and said source of water, and an air exhaust hose running from the inside of said enclosure to the outside thereof through which hot or cold air from said enclosure is exhausted to the atmosphere.

13. The plant growing system recited in claim 12, further comprising a source of carbon dioxide gas communicating with the inside of said enclosure for supplying carbon dioxide gas thereto.

14. The plant growing system recited in claim 13, further comprising means to control the temperature within said enclosure and the carbon dioxide gas being supplied from said source thereof to the inside of said enclosure.

15. A system for growing plants having roots, said system comprising:
a plant support frame having an inside and an outside and a plurality of openings formed therethrough, the plants to be grown being received and retained by respective ones of said plurality of openings such that the leaves of the plants are located at the inside of said plant support frame and the roots of the plants are located at the outside of said plant support frame;
at least first and second root irrigation channels surrounding said plant support frame and being spaced one above the other to receive the roots of the plants located outside said plant support frame;
a source of water; and
a water flow path communicating with said source of water by which water is circulated between said source and said first and second root irrigation channels.

16. The plant growing system recited in claim 15, wherein said water flow path includes a water inlet line to supply water from said source thereof to said second root irrigation channel, said second root irrigation channel lying above said first irrigation channel.

17. The plant growing system recited in claim 15, wherein said water flow path also includes a first water transfer line running from said second root irrigation channel to said first root irrigation channel and a second water transfer line running from said first root irrigation channel to said source of water.

18. The plant growing system recited in claim 15, wherein said water flow path also includes first and second water supply tubes attached to said plant support frame and communicating with one another, said first water supply tube lying above said first root irrigation channel, said second water supply tube lying above said second root irrigation channel, and said second water supply tube lying above said first water supply tube, and a water inlet line extending between said source of water and said second water supply tube.

19. The plant growing system recited in claim 18, wherein each of said first and second water supply tubes extends around said plant support frame and has a plurality of orifices formed therein, each of said plurality of orifices lying directly above the roots of a plant located outside said plant support frame such that water from said source of water drips onto the roots of the plants by way of said plurality of orifices.

20. The plant growing system recited in claim 19, wherein the water which drips through the plurality of orifices formed in said first water supply tube is collected by said first root irrigation channel, and the water which drips through the plurality of orifices formed in said second water supply line is collected by said second root irrigation channel.
